(19) United States
(12) Patent Application Publication
(10) Pub. No.: US 2006/0203874 A1
(43) Pub. Date: Sep. 14, 2006

(54) Backlight module and liquid crystal display having same

(75) Inventor: Yu-Ju Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/374,878

(22) Filed: Mar. 13, 2006

(30) Foreign Application Priority Data
Mar. 12, 2005 (CN) 200520055835.3

(51) Int. Cl. H01S 3/093

(52) U.S. Cl. 372/72

(57) ABSTRACT

An exemplary backlight module (2) includes a light guide plate (20) and a reflective plate (26). The light guide plate includes an incident surface (21) and a bottom surface (23) adjacent the incident surface. The reflective plate is disposed adjacent to the bottom surface, and includes a reflective projection (268) which faces the bottom surface. By adjusting a width, a height, a location and other parameters of the reflective projection, an emission brightness of the light guide plate is controllable.

### BACKGROUND

1. Field of the Invention

The present invention relates to backlight modules and liquid crystal displays having a backlight module.

2. General Background

A liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight module attached to the liquid crystal display.

Referring to FIG. 5, a conventional backlight module 1 generally includes a light source (not shown), a light guide plate 10, and a reflective plate 16. The light guide plate 10 includes a light incident surface 11, a light emission surface 12 perpendicularly adjacent the incident surface 11, a bottom surface 13 opposite to the light emission surface 12, and a plurality of side surfaces 14. The light source is disposed adjacent to the incident surface 11. The reflective plate 16 is disposed adjacent to the bottom surface 13. Light beams from the light source enter the light guide plate 10 through the incident surface 11. A portion of the light beams is reflected and scattered in the light guide plate 10, and then emits from the emission surface 12. Other light beams emit out from the light guide plate 10 via the bottom surface 13, and are reflected back into the light guide plate 10 by the reflective plate 16. In general, it is difficult to adjust or control the brightness of different regions of the light guide plate 10. That is, the brightness of light emitted from certain regions of the emission surface 12 may be insufficient, and the overall brightness of light emitted from the emission surface 12 may be non-uniform. Accordingly, the quality of light provided by the backlight module 1 may be unsatisfactory, and the quality of a display of an LCD having the backlight module 1 may be correspondingly poor.

Therefore, a new backlight module and a corresponding liquid crystal display that can overcome the above-described problems are desired.

### SUMMARY

In a preferred embodiment, a backlight module includes a light guide plate and a reflective plate. The light guide plate includes an incident surface and a bottom surface adjacent to the incident surface. The reflective plate is disposed adjacent to the bottom surface, and includes a reflective projection which faces the bottom surface.

Other advantages and novel features will become more apparent from the following detailed description when taken in conjunction with the accompanying drawings.

### BRIEF DESCRIPTION OF THE DRAWINGS

FIG. 1 is a schematic, partially exploded, side view of part of a liquid crystal display according to a first embodiment of the present invention.

FIG. 2 is a schematic, partially exploded, side view of a liquid crystal display according to a second embodiment of the present invention.

FIG. 3 is an isometric view of a reflective plate of a backlight module according to a third embodiment of the present invention.

FIG. 4 is an isometric view of a reflective plate of a backlight module according to a fourth embodiment of the present invention.

FIG. 5 is an exploded, isometric view of part of a conventional backlight module.

### DETAILED DESCRIPTION OF PREFERRED EMBODIMENTS

Referring to FIG. 1, a liquid crystal display (LCD) according to a first embodiment of the present invention includes a liquid crystal panel 29, and a backlight module 2 for illuminating the liquid crystal panel 29. The backlight module 2 includes a light source (not shown), a light guide plate 20, and a reflective plate 26. The light guide plate 20 includes a light incident surface 21, a light emission surface 22 perpendicularly adjacent the incident surface 21, a bottom surface 23 opposite to the emission surface 22, and a plurality of side surfaces 24. The reflective plate 16 is disposed adjacent to the bottom surface 23. The bottom surface 23 includes a recessed curved surface, such as a surface having a semi-elliptic profile. A material of the light guide plate 20 can be a transparent organic material such as polymethyl methacrylate (PMMA) or propylene carbonate (PC). The reflective plate 26 can be a mirror polished thin sheet made from a metal such as aluminum or silver. The reflective plate 26 includes a reflective projection 268 integrally formed therewith. The reflective projection 268 may be generally prismatic. That is, the reflective projection 268 may have a triangular cross-section, with a base of the triangle located at a main body of the reflective plate 26. The reflective projection 268 is accommodated in a recess defined by the bottom surface 23 of the light guide plate 20.

Light beams from the light source enter the light guide plate 20 through the incident surface 21. A portion of the light beams is reflected by the bottom surface 23 and the side surfaces 24, and then emits out from the emission surface 22. Other light beams emit out from the light guide plate 20 via the bottom surface 23, and are reflected back into the light guide plate 20 by the reflective plate 26 having the reflective projection 268. By adjusting a width, a height, a location and other parameters of the reflective projection 268, an emission brightness of the corresponding region of the emission surface 22 of the light guide plate 20 is controllable.

Referring to FIG. 2, a liquid crystal display according to a second embodiment of the present invention includes a liquid crystal panel 39, and a backlight module 3 for illuminating the liquid crystal panel 39. The backlight module 3 includes a light guide plate 30, a reflective plate 36, and two light source assemblies 37. The light guide plate 30 includes two opposite light incident surfaces 31, a light emission surface 32 between the incident surfaces 31, and a bottom surface 33 opposite to the emission surface 32. The bottom surface 33 comprises a recessed curved surface, such as a surface having a semi-elliptic profile. The two light source assemblies 37 are respectively disposed adjacent to the two incident surfaces 311 of the light guide plate 30. Each light source assembly 37 includes a light source 374, and a lampshade 375 partially enclosing the light source 374. The light source 374 is typically a light emitting diode (LED), a plurality of LEDs, or a cold cathode fluorescent lamp (CCFL). The lampshade 375 can reflect light beams received from the light source 374 back toward the corresponding incident surface 311 of the light guide plate 30. The reflective plate 36 is disposed adjacent to the bottom surface 33 of the light guide plate 30. The reflective plate 36 includes a reflective projection 368 integrated therewith. The reflective projection 368 has a partially columnar shape, with a curved surface thereof facing the bottom surface 33 of the light guide plate 30. The reflective projection 368 is accommodated in a recess defined by the bottom surface 33.

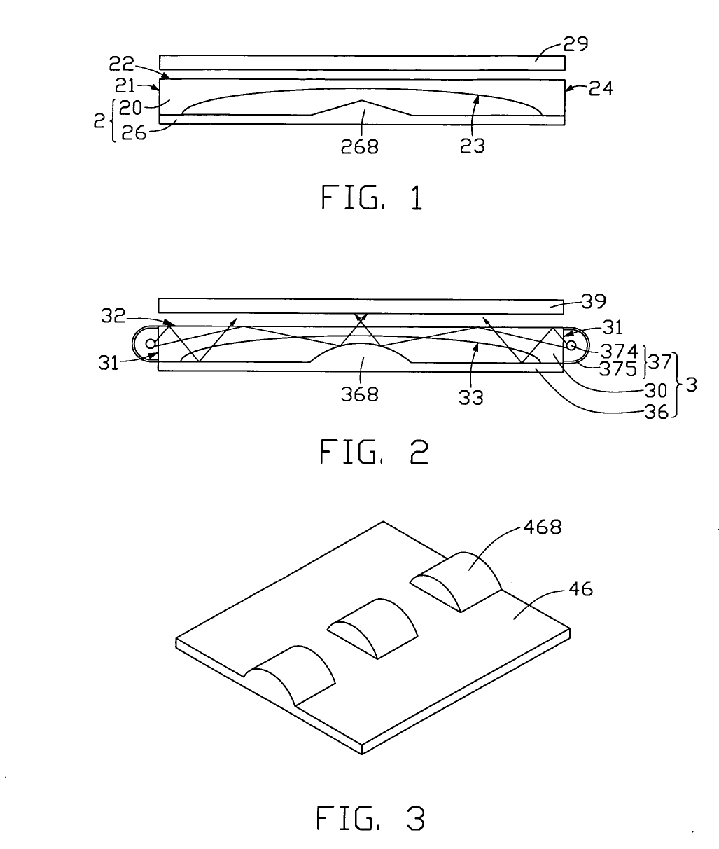

Referring to FIG. 3, a reflective plate 46 according to a third embodiment of the present invention includes a plurality of separate, aligned reflective projections 468 integrated therewith. Each reflective projection 468 has a partially columnar shape.

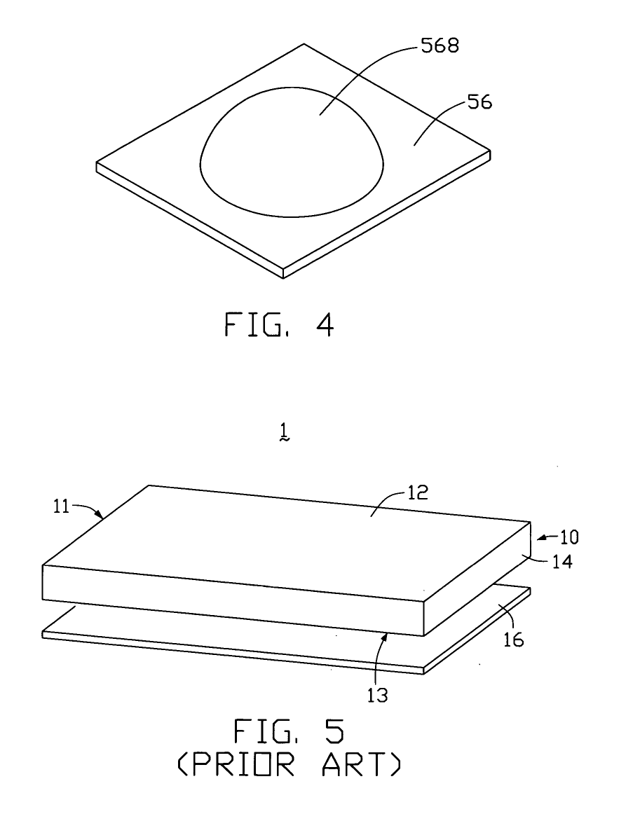

Referring to FIG. 4, a reflective plate 56 according to a fourth embodiment of the present invention includes a reflective projection 568 integrated therewith. The reflective projection 568 has a hemispherical or partially hemispherical shape.

Further alternative embodiments may include the following. A plurality of reflective elements can be respectively disposed adjacent to the plurality of side surfaces 24 of the light guide plate 20. The reflective elements can for example be reflective plates, layers, films, and/or coatings. The bottom surface 23, 33 of the light guide plate 20, 30 can comprise a recessed hemispherical or partially hemispherical surface. The backlight module 2, 3 can further include a diffusion sheet disposed adjacent to the emission surface 22, 32 of the light guide plate 20, 30.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate comprising an incident surface and a bottom surface adjacent to the incident surface; and
a reflective plate disposed adjacent to the bottom surface, and comprising a reflective projection which faces the bottom surface.

2. The backlight module as claimed in claim 1, wherein the bottom surface comprises a recessed surface.

3. The backlight module as claimed in claim 2, wherein the bottom surface comprises a curved surface.

4. The backlight module as claimed in claim 3, wherein the bottom surface comprises a surface having a semi-elliptic profile, a hemispherical surface, or a partially hemispherical surface.

5. The backlight module as claimed in claim 1, wherein the reflective projection is prismatic, partially columnar, hemispherical, or partially hemispherical.

6. The backlight module as claimed in claim 1, wherein the reflective projection is an integral part of the reflective plate.

7. The backlight module as claimed in claim 1, wherein the light guide plate further comprises a plurality of side surfaces adjacent to the bottom surface.

8. The backlight module as claimed in claim 7, further comprising a plurality of reflective elements respectively disposed adjacent to the side surfaces of the light guide plate.

9. The backlight module as claimed in claim 1, further comprising a light source disposed adjacent to the incident surface of the light guide plate.

10. The backlight module as claimed in claim 9, wherein the light source is a light emitting diode, a plurality of light emitting diodes, or a cold cathode fluorescent lamp.

11. The backlight module as claimed in claim 1, wherein the light guide plate further comprises an emission surface opposite to the bottom surface.

12. The backlight module as claimed in claim 11, further comprising a diffusion sheet disposed adjacent to the emission surface of the light guide plate.

13. A liquid crystal display comprising:
a liquid crystal panel; and
a backlight module for illuminating the liquid crystal panel, the backlight module comprising:
a light guide plate comprising an incident surface and a bottom surface adjacent to the incident surface; and
a reflective plate disposed adjacent to the bottom surface, and comprising a reflective projection which faces the bottom surface.

14. The liquid crystal display as claimed in claim 13, wherein the bottom surface comprises a recessed surface.

15. The liquid crystal display as claimed in claim 13, wherein the bottom surface comprises a curved surface.

16. The liquid crystal display as claimed in claim 13, wherein the bottom surface comprises a surface having a semi-elliptic profile, a hemispherical surface, or a partially hemispherical surface.

17. The liquid crystal display as claimed in claim 13, wherein the reflective projection is prismatic, partially columnar, hemispherical, or partially hemispherical.

18. The liquid crystal display as claimed in claim 13, wherein the backlight module further comprises a light source assembly disposed adjacent to the incident surface of the light guide plate.

19. The liquid crystal display as claimed in claim 18, wherein the light source assembly comprises a light source, and a lampshade partially enclosing the light source.

20. The liquid crystal display as claimed in claim 19, wherein the light source is a light emitting diode, a plurality of light emitting diodes, or a cold cathode fluorescent lamp.
